(19) United States
(12) Patent Application Publication
(10) Pub. No.: US 2002/0054718 A1
(43) Pub. Date: May 9, 2002

(54) Bidirectional radial foil bearing

(76) Inventor: Dennis H. Weissert, Simi Valley, CA (US)

Correspondence Address: IRELL & MANELLA LLP, Suite 900, 1800 Avenue of the Stars, Los Angeles, CA, 90067, US

(21) Appl. No.: 10/013,001

(22) Filed: Nov. 5, 2001

Related U.S. Application Data
(60) Provisional application No. 60/245,804, filed on Nov. 3, 2000.

(51) Int. Cl. F16C 32/06

(52) U.S. Cl. 384/104

(57) ABSTRACT

A bidirectional radial bearing for rotatably supporting a rotor or shaft may include a bushing with an interior bore having one or more antirotation retainers that may be equally spaced and extend the axial length of the interior bore. The interior bore of the bushing may be formed into a plurality of lobes. The interface of adjacent lobes and a compliant foil and a foil underspring form symmetrical converging wedges. The combination of the lobed bore and the compliant foil and foil underspring establish symmetrical converging wedges surrounding the rotor or shaft. In another aspect of the present invention, a single compliant foil may combine with the lobed bore and one or more foil undersprings to form two or more symmetrical converging wedges. It is emphasized that this abstract is provided to comply with the rules requiring an abstract which will allow a searcher or other reader to quickly ascertain the subject matter of the technical disclosure. It is submitted with the understanding that it will not be used to interpret or limit the scope or meaning of the claims.

### BACKGROUND OF THE INVENTION

### RELATED APPLICATIONS

This application claims the priority of U.S. provisional patent application Ser. No. 60/245,804, filed Nov, 3, 2000.

### FIELD OF THE INVENTION

This invention relates to the general field of compliant foil fluid film bearings and more particularly to bidirectional compliant foil fluid film radial bearings.

### DESCRIPTION OF THE PRIOR ART

Compliant foil fluid film radial bearings are currently being utilized in a variety of applications to support a rotating element such as a rotor or shaft. These bearings are generally composed of a bushing and one or more nonrotating foil members mounted within the bushing and a compliant spring foil member mounted within the bushing underneath each of the nonrotating compliant fluid foil members. The space between the rotating element and the bushing is filled with fluid, usually air, which envelops the foils.

What is needed is a radial bearing design requiring fewer internal parts for which rotation direction is immaterial.

### SUMMARY OF THE INVENTION

The present invention is directed to a bidirectional or symmetrical radial bearing comprising a bushing, one or more compliant foils, and one or more foil undersprings for supporting a shaft or a rotor.

In one aspect, a compliant foil radial bearing includes a bushing having an interior bore and an axial length, the interior bore including a plurality of lobes, and a foil retainer extending radially into the bore, and a compliant foil conforming to the plurality of lobes to form a like plurality of symmetrical wedges and a foil underspring array.

In another aspect, a bidirectional compliant foil fluid film radial bearing includes a bushing having an interior bore including a plurality of equally spaced retainers axially extending in said interior bore and a like plurality of arc segments between adjacent generally T-shaped retainers; a shaft rotatably supported within said interior bore of said bushing; a plurality of compliant foils, with an individual compliant foil disposed in said interior bore of said bushing between adjacent generally T-shaped retainers forming two symmetrical opposed aerodynamic wedges; and a plurality of foil undersprings, with an underspring disposed beneath each of said compliant foils between adjacent generally T-shaped retainers.

In another aspect, a compliant foil fluid film radial bearing includes a bushing having an interior bore, including a plurality of equally spaced retainers axially into said interior bore and a like plurality of contoured lobes, each of the plurality of contoured lobes centered on one of the plurality of equally spaced retainers; a shaft rotatably supported within said interior bore of said bushing; a plurality of compliant foils, each compliant foil disposed in the interior bore of the bushing between adjacent retainers, the contoured lobes between adjacent retainers establishing a converging wedge on the surface of said compliant foil facing said shaft; and a plurality of foil undersprings, with an underspring disposed between each of said compliant foils and the bushing between adjacent retainers.

In still another aspect, a compliant foil fluid film radial bearing includes a bushing having a noncylindrical interior bore, including a plurality of retainers axially extending into said interior bore; a plurality of compliant foils, with an individual compliant foil disposed in said interior bore of said bushing between adjacent retainers; and a plurality of foil undersprings, with an underspring disposed beneath each of said compliant foils between adjacent retainers, the contour of the interior bore between adjacent retainers establishing a converging wedge on each of said compliant foil. s

These and other features and advantages of this invention will become further apparent from the detailed description and accompanying figures that follow. In the figures and description, numerals indicate the various features of the invention, like numerals referring to like features throughout both the drawings and the description.

### BRIEF DESCRIPTION OF THE DRAWINGS

FIG. 1 is an end view of the compliant foil fluid film radial bearing of the present invention.

FIG. 2 is an exploded perspective view of the compliant foil fluid film radial bearing of FIG. 1.

FIG. 3 is an exploded perspective view of the compliant foil fluid film radial bearing of FIG. 1

FIG. 4 is an end view of the lobe construction of the compliant foil fluid film radial bearing of FIG. 1.

FIG. 5 is an end view of an alternate lobe construction according to the present invention.

FIG. 6A is an enlarged view of an underspring according to the present invention.

FIG. 6B is a sectional view of the underspring of FIG. 6A.

### DETAILED DESCRIPTION OF THE PREFERRED EMBODIMENT(S)

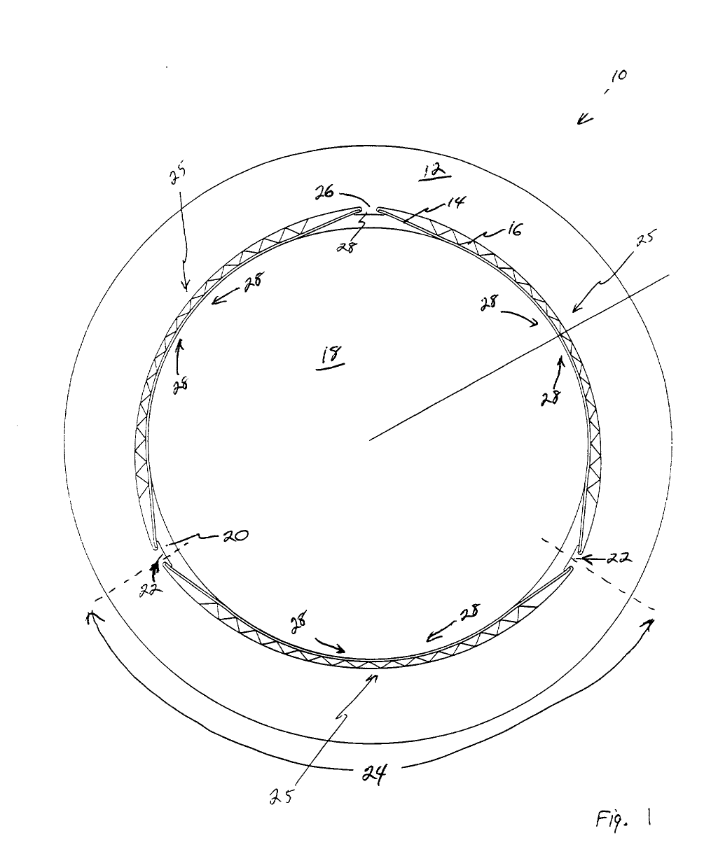

Referring now to FIG. 1, a radial bearing 10 according to the present invention may include bushing 12, one or more compliant foils 14 and one or more foil undersprings 16. A radial bearing according to the present invention provides support for a rotating shaft or rotor such as rotor 18.

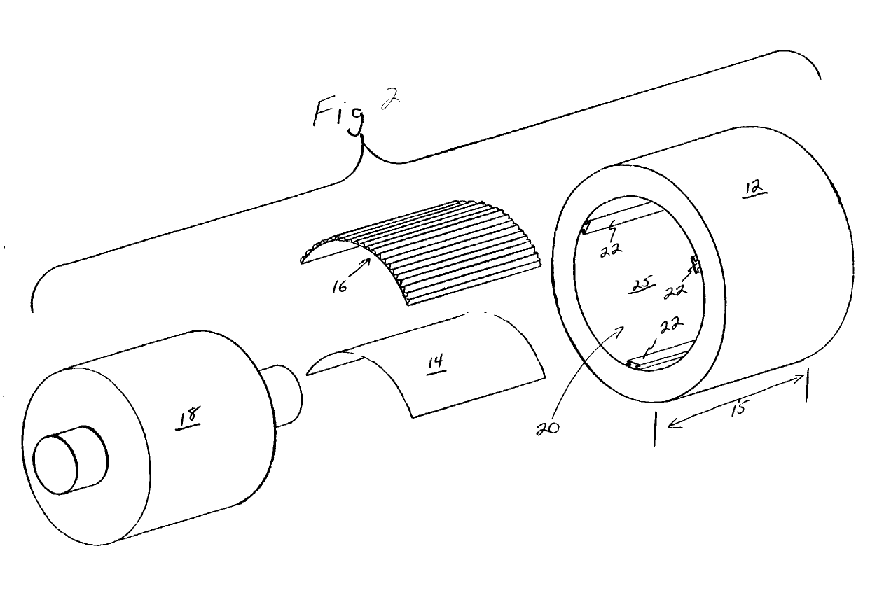

Interior bore 20 of the bushing 12 may include one or more antirotation devices or retainers 22. Retainers 22 shown in FIG. 1 may be generally T-shaped retainers, however, any suitable geometry may be used. In the currently preferred embodiment of the present invention, if more than one retainer 22 is used, retainers 22 are equally spaced and extend axial length 15 of the interior bore 20 as shown in FIG. 2. Retainers 22 may divide interior bore 20 of bushing 12 into a plurality of arc segments 24. Compliant foils 14 and foil undersprings 16 may be disposed in each arc segment 24 between adjacent retainers 22. Lobes 25 and compliant foil 14 and foil underspring 16 form two symmetrically opposed aerodynamic or converging wedges 28 in each arc segment 24. Retainers 22 may be formed as part of bore 20. Retainer base 26 extends radially inwards from bushing 12 into interior bore 20 and connects to a cross piece or other foil retaining member such as top 29.

While the shaft or rotor 18 is cylindrical, the interior bore 20 of the bushing 12 may or may not be cylindrical. In a currently preferred embodiment of the present invention, interior bore 20 is not cylindrical but includes two or more lobes 25.

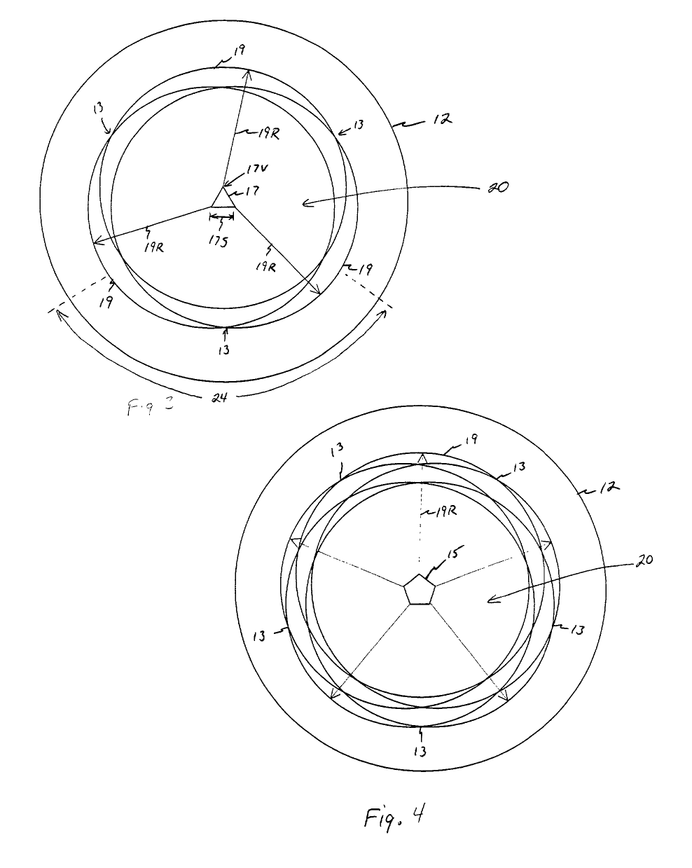

Referring now to FIG. 3, the contoured surface of lobes 25 may be derived from one or a series of radii of a defined profile. For example, in the case of a three-lobed bushing such as bushing 12, the contour of lobes 25 which form the aerodynamic wedges using compliant foils 14 and foil undersprings 16 may be derived using an equilateral triangle 17 centered in bore 20. The eccentricity of lobes 25 is a function of the length of the sides 17S of triangle 17 and radius 19R of circles 19 constructed from vertices 17V. The intersection of circles 19 determines the contour of lobes 25, which may be machined, ground, EDMed or broached. Retainers 22 will be located equidistant between the lobes 25 and will divide the interior bore 20 into a plurality of symmetrically shaped arc segments 24. This technique may be used with other shapes such as pentagon 15 shown in FIG. 4. Use of a shape having N sides will result in a bore having N lobes, and thus N symmetrical wedges.

Lobes 25 permit compliant foil 14 to adopt the contour of bore 20 to form aerodynamic wedges 28. Movement or expansion of compliant foil 14 relative to bushing 12 will not change the relative position of aerodynamic wedges 28. Lobes 25 may be arranged symmetrically within bore 20; thus aerodynamic wedges 28 are also symmetrical, allowing for rotation of shaft or rotor 18 in any direction.

While radial bearing 10 is shown with three compliant foils 14 and three foil undersprings 16, a greater or lesser number of compliant foils 14 and/or foil undersprings 16 may be utilized. For example, five or more segments may be equally appropriate for a compliant foil fluid film radial bearing as shown in FIG. 4.

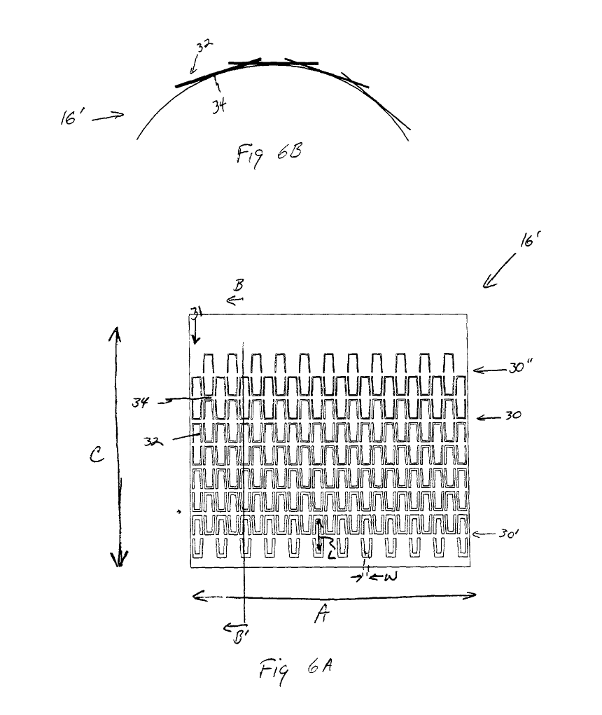

Compliant foils 14 and foil undersprings 16 may be trapped and held between adjacent retainers 22. Compliant foils 14 may have a preformed arcuate shape as shown in FIG. 2. Foil undersprings 16 may have a preformed radius or simply be a rectangular sheet as shown in FIG. 6A. In either case, compliant foils 14 and foil undersprings 16 are axially inserted, either separately or together, into the interior bore 20 of bushing 12. If two or more retainers are included, compliant foils 14 and foil undersprings 16 are axially inserted between adjacent retainers 22.

When captured between adjacent retainers 22, compliant foils 14 may be preloaded in compression between adjacent retainers 22. In some instances, however, compliant foils 14 may be merely retained in position between adjacent retainers 22 without preloading. Foil underspring 16 may contribute to the contoured shape of the compliant foils 14. In most instances, the compliant foils 14 and foil underspring 16 would be separate and would be capable of sliding movement therebetween.

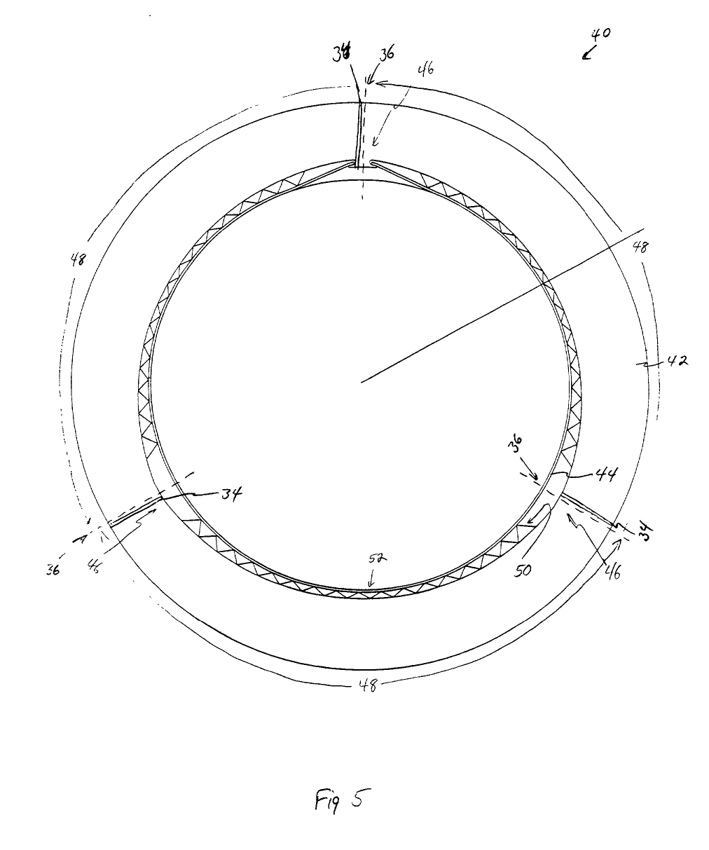

Referring now to FIG. 5, bearing 40 includes bushing 42 and compliant foil 44. Bushing 42 is shown as having three lobes 46 and three arc segments 48. Each arc segment 48 forms a symmetrical wedge 50 having a central point of compression 52. Bearing 40 may also include one or more radial openings 34 for improved bearing cooling. In a currently preferred embodiment, radial openings 34 are located between arc segments at segment interfaces 36.

While the foil undersprings 16 are illustrated in FIGS. 1 and 2 as a wavy springform, any conventional bearing underspring can be utilized, including the spring described in U.S. Pat. No. 5,427,455. Foil undersprings 16 may have variable spring rates or tapered heights from the leading edge to the trailing edge as shown in FIGS. 6A and 6B.

Referring now to FIG. 6A, in a currently preferred embodiment, foil underspring 16′ is a beam design having multiple rows 30 composed of a plurality of flexible beams 32. Foil underspring 16′ may provide variable spring rate in two dimensions, axial and circumferential. Any suitable mechanism for forming the beams may be used, such as stamping, machining, or chemical etching. Circumferential spring stiffness of foil underspring 16′ may be varied by controlling the length L and the width W of beams 32 within a row 30 and having different beam length L and width W in two or more rows 30. As shown in FIG. 2, along axis C each row 30 has increasing stiffness from row 30′ to row 30″, which would provide circumferentially varying stiffness.

Referring now to FIG. 6B, foil underspring 16′ is shown along B-B′ in an exaggerated bend. Beams 32 provide no spring effect unless foil underspring 16′ is bent as shown.

Axial spring stiffness may be varied by varying beam dimensions along axis A from column to column such as column 31. Controlling beam length L and width W of beams 32 within a column 31 and having different beam length L and width W in two or more columns 31, axial spring variation may be achieved. In a currently preferred embodiment, axial stiffness is varied along only one axial edge to accommodate varying shaft geometry driven by operational changes such as centrifugal growth or thermal gradients.

Radial bearing 10 of the present invention allows for automation by mass production, and the components can easily be assembled by hand. The compliant foils 14 may be machined, stamped, chemically etched or fine blanked. The large clearances between the compliant foils 14 and shaft 18 at retainers 22 allow improved cooling of the shaft and compliant foils 14. A radial bearing according to the present invention may accommodate a variety of underspring types and retainers 22 to permit more design flexibility with respect to the shaft, foil and spring interaction.

Referring again to FIG. 1, in an alternate embodiment, radial bearing 10 may have a cylindrical bore 20 and one or more retainers 26. A single foil 14 and underspring 16 may extend the circumference of bore 20 and be retained by retainer 26. One or more aerodynamic wedges 28 may be formed by movement of shaft 18.

Having now described the invention in accordance with the requirements of the patent statutes, those skilled in this art will understand how to make changes and modifications in the present invention to meet their specific requirements or conditions. Such changes and modifications may be made without departing from the scope and spirit of the invention as set forth in the following claims.

What I claim is:

1. A compliant foil radial bearing comprising:
a bushing having an interior bore and an axial length, the interior bore including a plurality of lobes;
a foil retainer extending radially into the bore;
a compliant foil conforming to the plurality of lobes to form a like plurality of symmetrical wedges; and
a foil underspring array.

2. The compliant foil radial bearing of claim 1 wherein the foil underspring array further comprises:
a plurality of foil underspring arrays, each foil underspring array supporting two of the like plurality of symmetrical wedges.

3. The compliant foil radial bearing of claim 1 wherein the foil retainer further comprises:
a generally T-shaped retainer extending into the bore and extending the axial length of the bore.

4. The compliant foil fluid film radial bearing of claim 1 wherein the plurality of lobes number from 2 to 12 inclusive.

5. The compliant foil fluid film radial bearing of claim 1 wherein the interior bore includes three lobes.

6. The compliant foil fluid film radial bearing of claim 1 further comprising:
a shaft rotatably supported within the interior bore.

7. A compliant foil fluid film radial bearing comprising:
a bushing having an interior bore including a plurality of equally spaced retainers axially extending in said interior bore and a like plurality of arc segments between adjacent generally T-shaped retainers;
a shaft rotatably supported within said interior bore of said bushing;
a plurality of compliant foils, with an individual compliant foil disposed in said interior bore of said bushing between adjacent generally T-shaped retainers forming two symmetrical opposed aerodynamic wedges; and
a plurality of foil undersprings, with an underspring disposed beneath each of said compliant foils between adjacent generally T-shaped retainers.

8. A compliant foil fluid film radial bearing comprising:
a bushing having an interior bore, including a plurality of equally spaced retainers axially into said interior bore and a like plurality of contoured lobes, each of the plurality of contoured lobes centered on one of the plurality of equally spaced retainers;
a shaft rotatably supported within said interior bore of said bushing;
a plurality of compliant foils, each compliant foil disposed in the interior bore of the bushing between adjacent retainers, the contoured lobes between adjacent retainers establishing a converging wedge on the surface of said compliant foil facing said shaft; and
a plurality of foil undersprings, with an underspring disposed between each of said compliant foils and the bushing between adjacent retainers.

9. The compliant foil fluid film radial bearing of claim 8 wherein said generally T-shaped retainers include radial openings to provide cooling flow to said interior bore of said bushing.

10. The compliant foil fluid film radial bearing of claim 8 further comprising:
means for providing cooling flow axially into said interior bore of said bushing.

11. A compliant foil fluid film radial bearing comprising:
a bushing having a noncylindrical interior bore, including a plurality of retainers axially extending into said interior bore;
a plurality of compliant foils, with an individual compliant foil disposed in said interior bore of said bushing between adjacent retainers; and
a plurality of foil undersprings, with an underspring disposed beneath each of said compliant foils between adjacent retainers, the contour of the interior bore between adjacent retainers establishing a converging wedge on each of said compliant foil.

12. The compliant foil fluid film radial bearing of claim 11 wherein said retainers are generally T-shaped.

13. The compliant foil fluid film radial bearing of claim 11 wherein said bearing is hydrodynamic.

14. The compliant foil fluid film radial bearing of claim 11 wherein said bearing is hydrostatic.

15. The compliant foil fluid film radial bearing of claim 11 wherein said generally T-shaped retainers include radial openings to provide cooling flow to said interior bore of said bushing.

16. The compliant foil fluid film radial bearing of claim 11 further comprising:
means to provide cooling flow axially into said interior bore of said bushing.
